(19) United States
(12) Patent Application Publication
(10) Pub. No.: US 2011/0074668 A1
(43) Pub. Date: Mar. 31, 2011

(54) CONTROL DEVICE

(75) Inventors: Subash MANDANAPU, San Bruno, CA (US); Satya MALLYA, San Jose, CA (US)

(73) Assignee: FRANCE TELECOM, Paris (FR)

(21) Appl. No.: 12/895,663

(22) Filed: Sep. 30, 2010

Related U.S. Application Data
(60) Provisional application No. 61/247,557, filed on Sep. 30, 2009.

(51) Int. Cl. G06F 3/01

(52) U.S. Cl. 345/156

(57) ABSTRACT

The present system relates to a device for imparting control to an application program. The device comprises a first sensor for carrying out a brainwave measurement when said first sensor is in contact with a user's head. The device further comprising a second sensor adapted to generate an output signal obtained from a measurement by the second sensor, when can for instance be a gyro sensor or a camera. The device is operable to use the output signal for imparting control to the application program in case the brainwave measurement falls outside a given interval of brainwave measurement values. The present system thus discloses a device that has an increased accuracy compared to the prior art devices.

### CROSS-REFERENCE TO RELATED APPLICATION

This application claims the benefit of U.S. Provisional Patent Application Ser. No. 61/247,557, filed Sep. 30, 2009, incorporated herein by reference thereto.

### FIELD OF THE PRESENT SYSTEM

The present system relates to a device for imparting control to an application program as well as to a method for imparting control to an application program as well as to a computer program for imparting control to an application program.

### BACKGROUND OF THE PRESENT SYSTEM

Devices for imparting control to an application program based on brainwave measurements are actually known. These devices exist in two varieties: “invasive devices” and “non-invasive devices”. An “invasive device” typically consists of a number of, for example, small needle like, electrodes which are inserted into the scalp of the head of a user and are thus in physical contact with it. In this way, it is possible to measure directly voltages that are generated by electrical activity along the skin produced by the firing of neurons within the brain of the user. Non-invasive devices, on the other hand are not in direct physical contact with the scalp but use contact electrodes. They comprise sensors in which voltages are recorded using Electroencephalography (EEG) technology. Non-invasive devices have the problem that a brainwave measurement by such a non-invasive device may not always be accurate due to physical factors (e.g., skull size), environmental factors, etc., and may not consistently reproduce the same reading under the same conditions.

An example of a non-invasive brainwave device can be found in U.S. Pat. No. 5,638,826, incorporated herein by reference thereto. This document describes a device that uses brainwaves as an input to control the movement of a cursor on a computer screen. The brainwaves, to which U.S. Pat. No. 5,638,826 refers as electroencephalographic activity or EEG activity, are collected by a microprocessor and converted into cursor movements. The device requires sophisticated tuning e.g. proper selection of intercepts and gains, in order to operate under all types of input of the user and may simply stop functioning when the input of the user is outside an interval of EEG activity established during this tuning phase. And, even after tuning, there may not be consistent repeatable readings.

There thus is a need today for a non-invasive brainwave device that is simpler and continues to operate in all circumstances.

### SUMMARY OF THE PRESENT SYSTEM

It is an object of the present system to overcome disadvantages and/or make improvements in the prior art. More in particular it is an object of the present system to provide a device for imparting control to an application program as well as a method for imparting control to an application program as well as a computer program for imparting control to an application program that are more accurate then those presently known.

The present system includes a device for imparting control to an application program, said device comprising a first sensor for carrying out a brainwave measurement when said first sensor is in contact with a user's head, said device further comprising a second sensor adapted to generate an output signal obtained from a measurement by said second sensor, said device being operable to use said output signal for imparting control to said application program in case said brainwave measurement falls outside a given interval of brainwave measurement values or the readings are insufficient in decision making process.

The present system also includes a method for imparting control to an application program, the method being carried out by a device comprising a first sensor adapted to be in contact with a user's head, comprising:

the act of carrying out a brainwave measurement by said first sensor, said method further comprising

the act of measuring an output signal generated by a second sensor,

the act of checking whether said brainwave measurement falls outside a given interval of brainwave measurements values, and, if this is the case,

the act of using said output signal for imparting said control to said application program.

The present system also includes a computer program for imparting control to an application program, said computer program being stored on a computer readable memory medium, said computer program comprising:
a program portion configured to carry out a brainwave measurement by a first sensor, when said first sensor is in contact with a user's head,

a program portion configured to check whether said brainwave measurement falls outside a given interval of brainwave measurements values,

a program portion configured to measure an output signal generated by a second sensor, and,

a program portion configured to use said output signal for imparting control to said application program.

Thanks to the present system, a device is provided that has an increased accuracy compared to the device with only the first sensor. When the brainwave measurement is outside the given interval, such a prior art device will simply not function whereas the device according to the present system will use the output of the available second sensor to control an application program.

### BRIEF DESCRIPTION OF THE DRAWINGS

The present system is explained in further detail, and by way of example, with reference to the accompanying drawings wherein:

FIG. 1 shows a device in accordance with embodiments of the present system; and

FIG. 2 shows an illustrative process flow diagram in accordance with embodiments of the present system; and

FIG. 3 shows an interpreter which is used in the device as shown in FIG. 1.

### DETAILED DESCRIPTION OF THE PRESENT SYSTEM

The following are descriptions of exemplary embodiments that when taken in conjunction with the drawings will demonstrate the above noted features and advantages, and introduce further ones.

In the following description, for purposes of explanation rather than limitation, specific details are set forth such as architecture, interfaces, techniques, devices etc., for illustration. However, it will be apparent to those of ordinary skill in the art that other embodiments that depart from these details would still be understood to be within the scope of the appended claims.

Moreover, for the purpose of clarity, detailed descriptions of well-known devices, systems, and methods are omitted so as not to obscure the description of the present system.

In the description here after, an application program (AP)—or software—may be seen as any tool that functions and is operated by means of a computer, with the purpose of performing one or more functions or tasks for a user or another application program. To interact with and control an application program, output from a first or a second sensor will be used to execute the functions/tasks from the application program.

The expression “application program” in the present description is thus to be taken in a very general sense, and meaning to cover both for instance the program that is present (“embedded”) in a television taking care of changing the channels of the latter (going to the next channel or going to the previous channel) as well as a word processor program (or other type of application software) which is typically running on a general purpose computer after having been loaded on it.

The expression “to control” is meant to imply an action (or an operation) by the device according to the present system that causes the application program to perform a certain task or functions.

The expressions “operatively linked”, “operatively coupled”, “coupled” and formatives thereof as utilized in this description refer to a connection between devices and/or portions thereof that enables operation in accordance with the present system. For example, an operative coupling may include one or more of a wired connection and/or a wireless connection between two or more sensors, a memory, an interpreter, an application program and a presenter that enables a one and/or two-way communication path between them. For example, an operative coupling may include a wired and/or wireless coupling to enable communication between them. An operative coupling may also relate to an interaction between program portions and thereby may not describe a physical connection so much as an interaction based coupling.

In addition, it should be expressly understood that the drawings are included for illustrative purposes and do not represent the scope of the present system. In the accompanying drawings, like reference numbers in different drawings may designate similar elements.

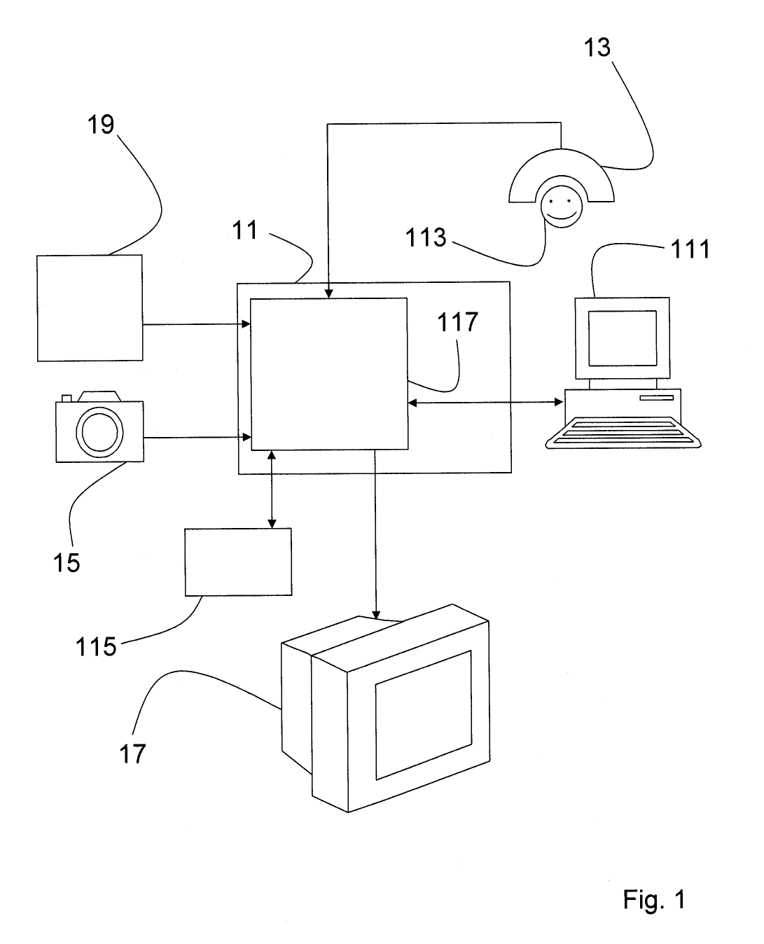

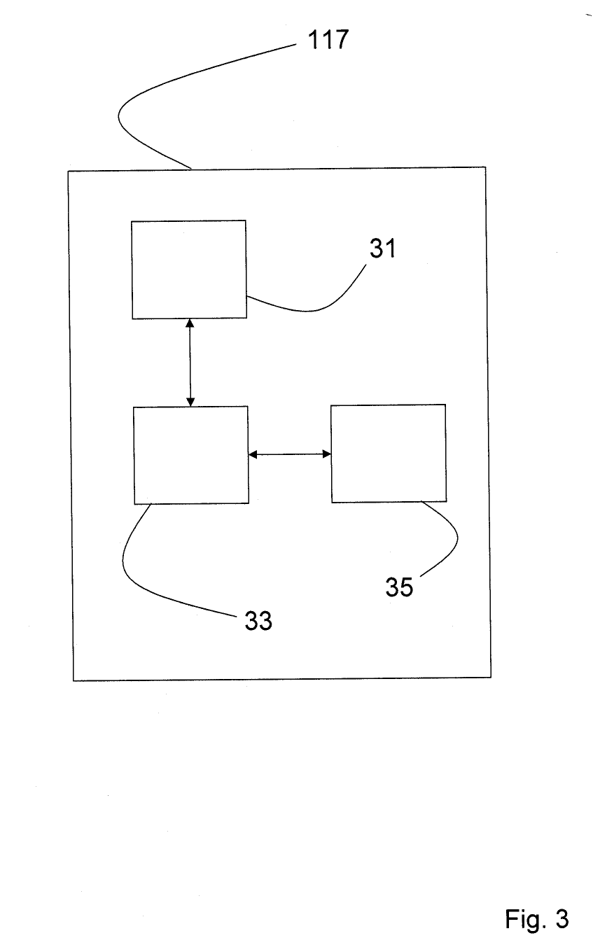

FIG. 1 is an illustration of an exemplary device 11 according to an embodiment of the present system. The device 11 comprises a first sensor 13 (or brainwave sensor) for carrying out a brainwave measurement on a user 113. An example of such a first sensor is the “Mindset” marketed by the company Nuerosky. When the device 11 is in operation, for instance when the device is placed on a user 113's head, there is some kind of contact between the first sensor 13 and the head of this user 113. The sensor can for instance in direct contact with the head of the user 113. Another possibility is that the first sensor is placed around the head of the user 113. What matters here is that the first sensor 13 is capable of picking up the in general small, voltages generated by the user 113's head when the user 113 thinks about a certain kind of action, for instance going to the next channel on a television or deleting a wrongly typed character on a computer screen. The first sensor 13 will be able to pick up these voltages also when there is no physical contact and even a small space or air gap between the head of the user 113 and the first sensor 13. The space will lead to some noise on the signal which however can be filtered-out using one or more techniques understood by those of ordinary skill in the art. The first sensor 13 may comprise several sub sensors to monitor various areas in the brain which correspond to various actions. For instance, the central vertex is used for decision making, the front vertex for looking at visuals, etc. The sub sensors may thus be dispersed over the head to grab these various activities. The device 11 further comprises a second sensor 15. This second sensor 15 is adapted to generate an output signal obtained from a measurement by this second sensor 15. The second sensor 15 can be for instance a gyro sensor or a camera. Using a gyro sensor has the advantage that such a sensor is very accurate and it is possible to establish beyond any doubt the difference between nodding and shaking for instance, with such a gyro sensor. Further examples for the second sensor 15 are a keyboard, touchpad or a simple button for instance on a remote control for a television, which remote control is operatively linked to the present device 11. As will be noted, the first sensor 13 differs from the other sensors, i.e. the second sensor 15 and the additional sensor 19, in that the other sensors measure a direct input by the user like gesture/motion, as opposed to the first sensor that is operable to pick up a brain voltage. Gesture/motion can directly be picked up by a gyro sensor and/or a camera. The device 11 also comprises an interpreter 117 the functioning of which will be explained in detail in FIG. 3. The device 11 is operable to impart control to an application program 17. The control can be imparted by a link to the application program which link can be established by means of a direct connection (wired or wireless) to the application program 17 or alternatively by a computer program that acts as an intermediary between the device 11 and the application program 17.

Although the previous explanation has been made with the example of only one second sensor 15, in embodiments of the present system, the device may comprise an additional sensor 19 or many additional sensors. These sensors may generate additional output signals which can be used individually or in combination to impart control to the application program. In this way, when one sensor is not operating or is otherwise malfunctioning, another sensor can take over.

In an embodiment of the present system, the device 11 comprises further a presenter or display 111 for instance a computer screen which can be used to present questions to the user 113, for instance a question like “do you want to go to the next channel?” The presenter 111 however can also be as simple as a lead. In the latter case, when the lead goes on, this would mean presenting to the user 113 the question “do you want to go to the next channel?” The questions on the presenter 111 are answered using the second sensor 15. The presenter 111 is used as an indication to the user 113 that the measurement by the first sensor 13 was not conclusive and that a feedback from the user 113, with the second sensor 15, is required.

The sensors described in this description, such as the first sensor 13, the second sensor 15, and, if applicable, further sensors such as the additional sensor 19 and, if present, the presenter 111 are operatively linked to the device 11, the interpreter 117 and the application program 17. It should thus be noted that there does not need to be a physical link between the second sensor 15 and the device 11.

The device 11 could be in the form of a helmet comprising the first sensor 13 and operatively linked to the second sensor 15 and the presenter 111. The helmet may also be a physical entity apart from the gyro sensor, which however can be attached to the helmet. In this way, the gyro sensor is able to detect movements of the user 113's head like tilting and/or nodding and/or rotating to the left or to the right. Alternatively, the gyro sensor may be attached to an arm of the user 113 though e.g. a strap. The camera on the other hand will be placed some distance away from the user in order to be able to detect movements of the latter.

As will be understood from the previous lines, the device 11 thus could be in one part or could comprise different parts operatively linked together.

Furthermore, the application program 17 may be running on the device 11 or on a distant device, for instance a television, operatively linked to the device 11.

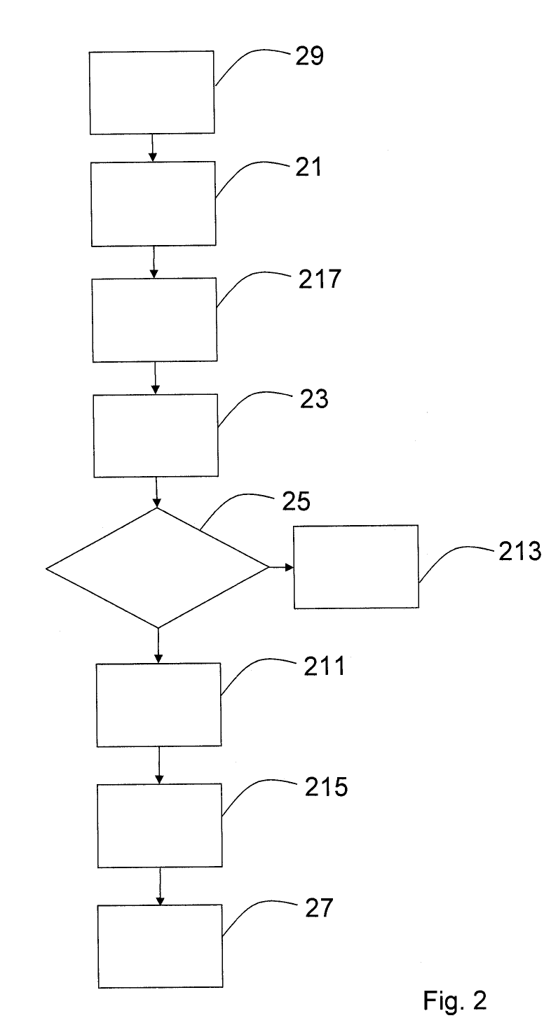

FIG. 2 explains how the device 11 functions. The method according to the present system comprises the act 21 of carrying out a brainwave measurement by the first sensor 13. The method also comprises the act 23 of measuring an output signal generated by the second sensor 15. This output signal can for instance originate from a gyro sensor or a camera. The output signal is generated by the user 113, for instance during movement of his head. It should be noted that the act 21 of carrying out the brainwave measurement can be before, (partly) at the same time or completely after the act 23 of measuring the output signal generated by the second sensor 15. It can thus be said that the device 11 operates at different levels (or stages): a first stage during which the first sensor 13 is used and a second stage during which the other (non brainwave based) sensors are used. The method further comprises the act 25 of checking whether the brainwave measurement falls outside a given defined interval of brainwave measurements values. If the latter is the case, the method comprises the act 27 of using the output signal for imparting control to the application program 17. An example of such control is for instance going to the next channel on a television or deleting a wrongly typed character on a computer screen.

If the brainwave measurement on the contrary is inside the given interval, the method continues to a next act 213 and imparts control to the application program based on this brainwave measurement only.

In an embodiment of the present system, the act 21 of carrying out said brainwave measurement and the act 23 of measuring said output signal are carried out at the same time. This has the advantage that the method will be faster, as the output signal is already available in case the brainwave measurement falls outside the given interval of brainwave measurements.

We will now explain the above acts in more detail. In this explanation we will assume that brainwave readings are in Ω. The corresponding values are for purpose of illustration. We will also assume that when a user 113 is thinking about going to the next channel, the correspondent brainwave measurements are all in an interval between 270Ω and 290Ω. The application program 17 is thus a program for remote control of a television. The application program 17 may be part of the device 11 according to the present system, stored on a remote control or on the television for instance. Let us now suppose that as a result of the act 21 of carrying out a brainwave measurement by the first sensor 13, a value of 300Ω is found. This is outside of the interval between 270Ω and 290Ω, as will be established during the act 25 of checking whether said brainwave measurement falls outside a given interval of brainwave measurements values. However, an output signal, which is the result of the user 113's interaction with the second sensor 15 in act 23, is available from the second sensor 15. If this second sensor is a gyro sensor, it can be programmed, as will be understood by those of ordinary skill in the art, in such a way that nodding to the right means “go to the next channel” and nodding to the left means “go to the previous channel”. The output from the gyro sensor will thus be processed by the interpreter 117 (note that the latter will be explained in more detail with reference to FIG. 3) and compared to a data base of gestures. As each gesture in the data base corresponds a control for the application program 17, the output from the gyro sensor is used to impart control to the application program 17. Hardware and software architectures to analyse and identify the output from the gyro sensor are for instance described in the co-pending application US 2007/0174416 incorporated herein by reference. The user 113 may generate the output signal as soon as he realizes that thinking about going to the next channel does not have the desired effect. In this case, the output signal is thus specific in that it can have only one of two meanings, namely “go to the next channel” or “go to the previous channel”.

In an embodiment of the present system, the method comprises the act 211 of presenting the control to the user 113 on the presenter 111 and the act 215 of carrying out the control in accordance with a confirmation of the user 113. For example, the user 113 has to answer the question on the presenter 111 “do you confirm that you want to go to the next channel?” The device 11 will present this question on the presenter 111, because the measured 300Ω, see above, is quite close to the interval between 270Ω and 290Ω. The device 11 thus assumes that the user 113 is thinking about going to the next channel. In this embodiment, the gyro sensor should be programmed, as will be understood by the person skilled in the art, in such a way that if the user 113 nods, this would mean “yes” and if the user 113 shakes his head, this would mean “no”. In this case, the output signal is very general. It can as a consequence also be used to answer other type of questions on the presenter 111 for instance “do you confirm that you want to delete the last character you typed?”

The question that will be displayed on the presenter 111 depends on the value measured during the act 21 of carrying out the brainwave measurement by the first sensor 13.

In another embodiment, the method comprises the act 217 of prompting the user 113 by a message on the presenter 111 to generate the output signal for input to the second sensor 15. The message could then for instance be: “brainwave reading not conclusive, please use your gyro sensor to control your television”. Thus in case that the second sensor 15 is a gyro sensor attached to the user 113, he has to move his head in a certain way. If the second sensor 15 is a keyboard, a menu with options can be presented on the presenter 111 and the user just presses a key on the keyboard to generate his input. The second sensor 15 could also be a keypad with a more limited number of keys but functioning in a way comparable to the way the keyboard functions in the framework of this present system. The second sensor 15 can also be the remote control itself.

In another embodiment, the method comprises the act 29 of establishing the interval as a function of brainwave measurement values carried out on the user 113. In this way, the device 11 can be trained (or tuned) to be used with different users. During the act 29 of establishing the interval, the user 113 is asked to think about going to the next channel on a television and the corresponding brainwave measurements are recorded, for instance in a data base. It is thus established that when he is thinking about going to the next channel, the correspondent brainwave measurements are all in an interval between 270Ω and 290Ω. Whereas in this example the interval is thus established based on two measurements, it is also possible to use 10 measurements to establish this interval. In principle, it is also possible to establish the interval “negatively” i.e. to ask the user not to think of going to the next channel, but on the contrary ask him to think about going to the previous channel and then excluding the measured value from interval. It should be noted that for another user than the user 113, this interval will be different and that for another action, for instance going one channel down or deleting a wrongly typed character on a computer screen, it will be different as well. The device 11 is able to store all those intervals in a data base as will be explained below with reference to FIG. 3. In this way, the device 11 can be used by more users than only the user 113 and for many different actions.

It is possible to establish many intervals corresponding too many types of control. For instance, the interval between 270Ω and 290Ω corresponding to thinking about going to the next channel, the interval between 370Ω and 390Ω corresponding to thinking about going to the previous channel, the interval between 470Ω and 490Ω corresponding to thinking about deleting the last character typed and the interval between 570Ω and 590Ω corresponding to thinking “yes”.

FIG. 3 explains the interpreter 117 in more detail. The interpreter 117 comprises a converter unit 31, a data base 35 such as a hard disk or other storage unit and a processing unit 33, for instance a microprocessor.

The interpreter 117 functions in the following way. The converter unit converts raw measured data obtained from the first sensor 13, the second sensor 15 and/or, if applicable, the additional sensor 19 in signal patterns. These raw data comprises for instance voltages induced in the first sensor 13 and/or voltages measured by the other sensors as a result of an input provided by the user 113. The converter unit 31 receives the raw data, processes them, for instance averages them over time, and converts them into a signal pattern. The data base 35 contains pre stored signal patterns, for instance a brainwave signal pattern corresponding to a brainwave which has been generated by the user 113's for instance when he thinks “yes”. The data base 35 also contains a gyro sensor signal pattern corresponding to certain movements of the user 113's head, e.g. a gyro sensor signal patterns corresponding to nodding “yes”. The data base will however contain several signal patterns corresponding to the same action of the user, as explained above for instance the interval between 570Ω and 590Ω corresponding to thinking “yes”.

In operation, the processing unit 33 receives the signal patterns from the converter unit 31. For instance, the processing unit 33 receives a brainwave signal pattern of 600Ω which is outside the interval between 570Ω and 590Ω corresponding to thinking “yes”. The processing unit 33 queries the data base 35 to see whether it contains a brainwave signal corresponding to 600Ω and will determine that this is not the case. However, processing unit 33 has also received the gyro sensor signal pattern. The processing unit 33 will now again query the data base 35 and compare the stored gyro signal patterns with the gyro signal pattern received in order to determine how the user 113 wants to control the application program 17. The processing unit 33, will in this case however find a match, and thereafter, translate the sensor readings into control signals for the application program 17, e.g. for running tasks and/or functions of the application program 17. The processing unit 33 also decides on what type of message is displayed on the presenter 111 as a function of the input signals the processing unit receives.

The device and method described herein are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as a memory 115 coupled to the device 11 and the interpreter 117.

The computer-readable medium and/or memory 115 may be any recordable medium (e.g., RAM, ROM, removable memory, CD-ROM, hard drives, DVD, floppy disks or memory cards) or may be a transmission medium utilizing one or more of radio frequency (RF) coupling, Bluetooth coupling, infrared coupling, etc. Any medium known or developed that can store and/or transmit information suitable for use with a computer system may be used as the computer-readable medium and/or memory 115. The computer software program may be received by the processing unit 33 for configuring (e.g., programming) the processing unit 33 to become a special purpose processor for performing operation acts in accordance with the present system. The processing unit 33 so configured becomes a special purpose machine particularly suited for performing in accordance with the present system.

Additional memories may also be used. These memories configure the device 11 to implement the methods, operational acts, and functions disclosed herein.

Moreover, the term “memory” should be construed broadly enough to encompass any information able to be read from or written to an address in the addressable space accessed by a processor. With this definition, information on a network is still within memory 115, for instance, because the device 11 may retrieve information from a network for operation in accordance with the present system.

The device 11 is capable of providing control signals and/or performing operations in response to input signals from the first sensor 13 and/or the second sensor 15 and/or the additional sensor 19 and executing instructions stored in the memory 115. The device 11 may be an application-specific or general-use integrated circuit(s). Further, the device 11 may be a dedicated processor for performing in accordance with the present system or may be a general-purpose processor wherein only one of many functions operates for performing in accordance with the present system. The device 11 may operate utilizing a program portion, multiple program segments, or may be a hardware device utilizing a dedicated or multi-purpose integrated circuit.

Finally, the above discussion is intended to be merely illustrative of the present system and should not be construed as limiting the appended claims to any particular embodiment or group of embodiments. Thus, while the present system has been described with reference to exemplary embodiments, including user 113 interfaces, it should also be appreciated that numerous modifications and alternative embodiments may be devised by those having ordinary skill in the art without departing from the broader and intended spirit and scope of the present system as set forth in the claims that follow.

The section headings included herein are intended to facilitate a review but are not intended to limit the scope of the present system. Accordingly, the description and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise;
h) no specific sequence of acts or steps is intended to be required unless specifically indicated; and
i) the term “plurality of” an element includes two or more of the claimed element, and does not imply any particular range of number of elements; that is, a plurality of elements may be as few as two elements, and may include an immeasurable number of elements.

What is claimed is:

1. A device for imparting control to an application program, said device comprising a first sensor for carrying out a brainwave measurement when said first sensor is in contact with a user's head, said device further comprising a second sensor adapted to generate an output signal obtained from a measurement by said second sensor, said device being operable to use said output signal for imparting control to said application program if said brainwave measurement falls outside a given interval of brainwave measurement values.

2. The device of claim 1 wherein the second sensor is a gyro sensor.

3. The device of claim 1 wherein the second sensor is a camera.

4. The device of claim 1 further operable to present the control to the user on a presenter and to carry out said control in accordance with a confirmation of said user.

5. The device of claim 1 further operable to establish the interval as a function of brainwave measurements values carried out on the user.

6. The device of claim 1 further operable to prompt the user by means of a message displayed on a presenter to generate the output signal.

7. The device of claim 1 further operable to carry out the brainwave measurement and to generate the output signal at the same time.

8. A method for imparting control to an application program, the method being carried out by a device comprising a first sensor adapted to be in contact with a user's head, comprising:
the act of carrying out a brainwave measurement by said first sensor, said method further comprising
the act of measuring an output signal generated by a second sensor,
the act of checking whether said brainwave measurement falls outside a given interval of brainwave measurement values, and
the act of using said output signal for imparting said control to said application program if said brainwave measurement falls outside the given interval of brainwave measurement values.

9. The method of claim 6 wherein the second sensor is a gyro sensor.

10. The method of claim 6 wherein the second sensor is a camera.

11. The method of claim 6 further comprising the act of presenting the control to the user on a presenter and the act of carrying out said control in accordance with a confirmation of said user.

12. The method of claim 6 further comprising the act of establishing the interval as a function of brainwave measurements values carried out on the user.

13. The method of claim 6 further comprising the act of prompting said user by means of a message displayed on a presenter to generate said output signal.

14. The method of claim 6 wherein the act of carrying out said brainwave measurement and the act of measuring said output signal are carried out at the same time.

15. A computer program for imparting control to an application program, said computer program being stored on a computer readable memory medium, said computer program comprising:
a program portion configured to carry out a brainwave measurement by a first sensor, when said first sensor is in contact with a user's head,
a program portion configured to check whether said brainwave measurement falls outside a given interval of brainwave measurement values,
a program portion configured to measure an output signal generated by a second sensor, and,
a program portion configured to use said output signal for imparting control to said application program if said brainwave measurement falls outside the given interval of brainwave measurement values.

16. The computer program of claim 15 further comprising a program portion configured to present the control to the user on a presenter and to carry out said control in accordance with a confirmation of said user.

17. The computer program of claim 15 further comprising a program portion configured to establish the interval as a function of brainwave measurements values carried out on the user.

18. The computer program of claim 15 further comprising a program portion configured to prompt the user by means of a message displayed on a presenter to generate the output signal.

19. The computer program of claim 15 further comprising a program portion configured to carry out the brainwave measurement and to measure the output signal at the same time.
